(19) United States
(12) Patent Application Publication
(10) Pub. No.: US 2015/0012437 A1
(43) Pub. Date: Jan. 8, 2015

(54) AUTHENTICATION SYSTEM AND METHOD USING MOBILE TERMINAL

(71) Applicant: BRANDOM, Seoul (KR)

(72) Inventors: Sung Kuk PARK, Gyeonggi-do (KR); Seung Hwan OH, Gyeonggi-do (KR)

(21) Appl. No.: 14/323,176

(22) Filed: Jul. 3, 2014

Related U.S. Application Data
(60) Provisional application No. 61/842,669, filed on Jul. 3, 2013.

(30) Foreign Application Priority Data
Jun. 27, 2014 (KR) 10-2014-0079953

(51) Int. Cl. G06Q 20/40; G06Q 20/32

(52) U.S. Cl. CPC G06Q 20/4014; G06Q 20/3278
USPC 705/44

(57) ABSTRACT

Provided are an authentication system and method using a mobile terminal. The authentication method includes: includes: receiving a mobile terminal identifier and a card identifier from a user's mobile terminal, wherein the card identifier is obtained from a user's card by the user's mobile terminal via Near Field Communication (NFC); searching for a member identifier of the authentication system corresponding to the mobile terminal identifier; checking whether the card identifier received from the user's mobile terminal is included in a card identifier list registered with the authentication system along with the member identifier; and generating the result of user authentication based on the result of checking of whether the card identifier is included in the card identifier list.

### RELATED APPLICATIONS

This application claims the benefit of U.S. Provisional Application No. 61/842,669, filed on Jul. 3, 2013, in the US Patent Office and Korean Patent Application No. 10-2014-0079953, filed on Jun. 27, 2014, in the Korean Intellectual Property Office, the disclosures of which are incorporated herein in their entireties by reference.

### BACKGROUND OF THE INVENTION

1. Field

One or more embodiments of the present invention relate to an authentication system and method using a mobile terminal, and more particularly, to an authentication system and method using a mobile terminal, which are capable of performing user authentication in a safe and convenient way.

2. Description of the Related Art

With technological advances in electronic equipment and communication networks, mobile terminals are increasingly being used in a variety of applications, such as social networking, clouding computing, mobile banking, and electronic commerce, beyond simple communication functions. Due to mobility and convenience of mobile terminals, the range of their applications has increased. As mobile terminals become widely used in various fields, accurate user authentication is required.

### SUMMARY OF THE INVENTION

One or more embodiments of the present invention include an authentication system and method using a mobile terminal, which are capable of performing user authentication in a safe and convenient way.

Additional aspects will be set forth in part in the description which follows and, in part, will be apparent from the description, or may be learned by practice of the presented embodiments.

According to one or more embodiments of the present invention, an authentication method that is performed by an authentication system includes: receiving from a user's mobile terminal a mobile terminal identifier and a card identifier, wherein the card identifier is obtained from a user's card by the user's mobile terminal via Near Field Communication (NFC); searching for a member identifier of the authentication system corresponding to the mobile terminal identifier; checking whether the card identifier received from the user's mobile terminal is included in a card identifier list registered with the authentication system along with the member identifier; and generating the result of user authentication based on the result of checking of whether the card identifier is included in the card identifier list.

According to one or more embodiments of the present invention, an authentication method performed in a mobile terminal includes: receiving a card identifier from a user's card via NFC; transmitting a mobile terminal identifier and the card identifier to an external authentication system; receiving an authentication result from the external authentication system based on the mobile terminal identifier and the card identifier; and processing an authentication procedure required for an application program downloaded to the mobile terminal, based on the authentication result.

An authentication system and method using a mobile terminal according to exemplary embodiments of the present invention are capable of conveniently performing authentication via a mobile terminal without needing to store information required for authentication such as card information in the mobile terminal.

The authentication system and method using a mobile terminal are capable of performing an authentication operation in a safe and secure way without needing to store information required for authentication such as card information in the mobile terminal.

### BRIEF DESCRIPTION OF THE DRAWINGS

These and/or other aspects will become apparent and more readily appreciated from the following description of the embodiments, taken in conjunction with the accompanying drawings in which:

FIG. 1 is a flowchart of an authentication method that is performed by an authentication system, according to an exemplary embodiment of the present invention;

FIG. 2 illustrates an authentication system according to an exemplary embodiment of the present invention;

FIG. 3 is a flowchart of an authentication method that is performed by an authentication system, according to another exemplary embodiment of the present invention;

FIG. 4 illustrates an authentication system according to another exemplary embodiment of the present invention;

FIG. 5 illustrates an authentication system according to another exemplary embodiment of the present invention and an authentication method performed by the authentication system;

FIG. 6 is a flowchart of an authentication method that is performed by an authentication system, according to another exemplary embodiment of the present invention; and

FIGS. 7 and 8 illustrate authentication systems and methods according to other exemplary embodiment of the present invention.

### DETAILED DESCRIPTION OF THE INVENTION

The accompanying drawings in which exemplary embodiments are illustrated and information described in the drawings have to be referred to in order to fully understand benefits of the present invention and the purpose to be achieved by implementation of the present invention. Reference will now be made in detail to embodiments, examples of which are illustrated in the accompanying drawings, wherein like reference numerals refer to like elements throughout. Expressions such as “at least one of,” when preceding a list of elements, modify the entire list of elements and do not modify the individual elements of the list.

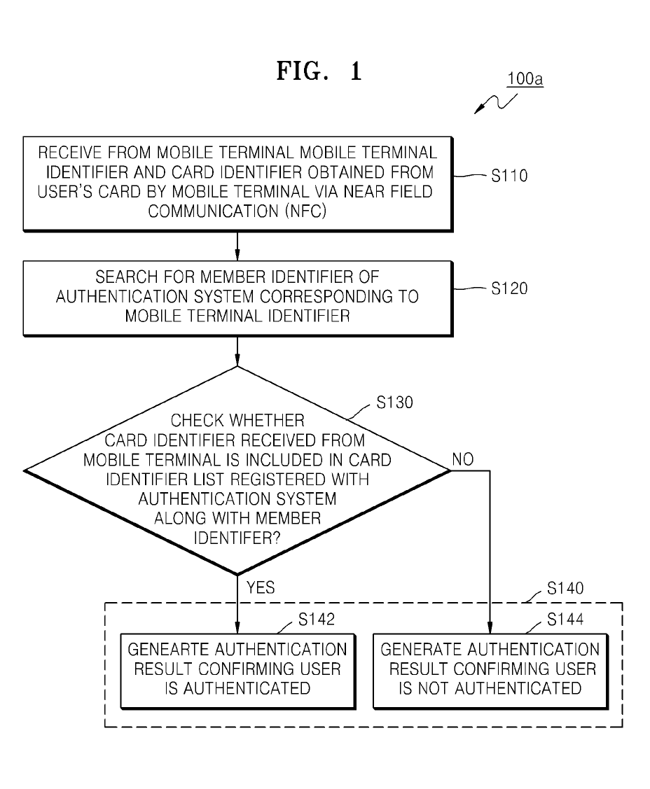

FIG. 1 is a flowchart of an authentication method 100a that is performed by an authentication system, according to an exemplary embodiment of the present invention. Referring to FIG. 1, the authentication method 100a includes operations of receiving from a user's mobile terminal a mobile terminal identifier and a card identifier (S110), searching for a member identifier of an authentication system corresponding to the mobile terminal identifier (S120), checking whether the card identifier received from the user's mobile terminal is contained in a card identifier list registered with the authentication system (S130) along with the member identifier, and generating the result of user authentication based on the result obtained in operation S130 (S140). The card identifier is obtained from a user's card by the user's mobile terminal via Near Field Communication (NFC).

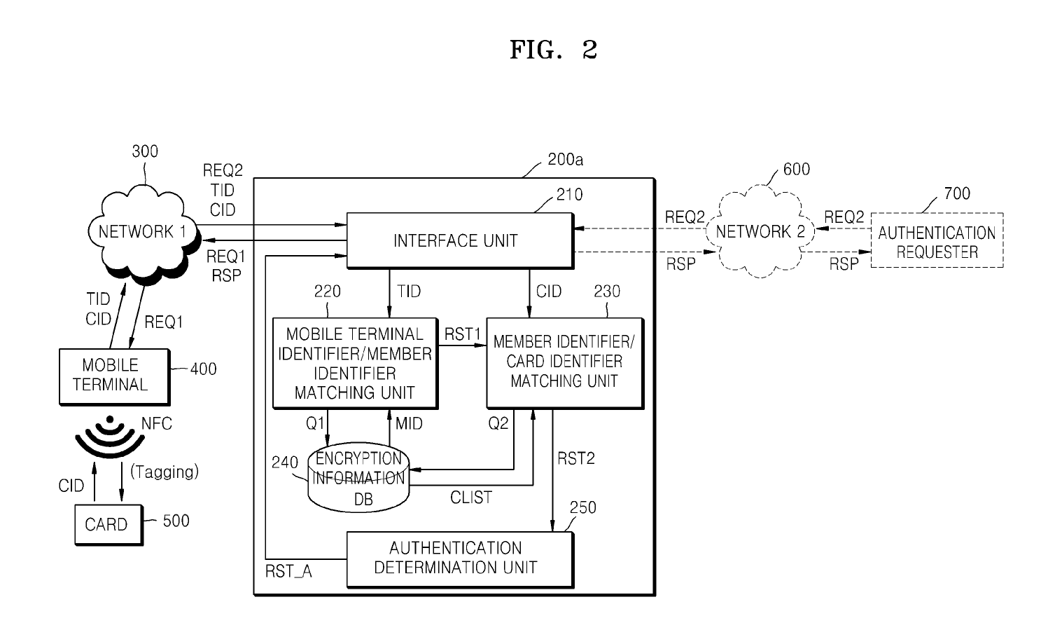

The operations S110 through S140 of the authentication method 100a illustrated in FIG. 1 will now be described in more detail with reference to FIG. 2. The authentication method 100a may be performed by an authentication system 200a of FIG. 2. However, the present invention is not limited thereto, and the authentication method 100a may be performed by an authentication system other than the authentication system 200a of FIG. 2. Referring to FIGS. 1 and 2, the authentication system 200a includes an interface unit 210, a mobile terminal identifier/member identifier matching unit 220, a member identifier/card identifier matching unit 230, an encryption information database (DB) 240, and an authentication determination unit 250.

The interface unit 210 receives a mobile terminal identifier TID and a card identifier CID from a mobile terminal 400 (S110). The mobile terminal identifier TID may be generated automatically and transmitted by a telecommunication service provider when the mobile terminal 400 communicates with the authentication system 200a via a first network 300. The first network 300 may be a communication network such as Wireless-Fidelity (Wi-Fi), Third Generation (3G), and Long-Term Evolution (LTE) networks. The card identifier CID may be obtained from a card 500 when the mobile terminal tags an NFC tag of the card 500. The card 500 may be a credit card, a debit card, an identity card, a membership card, or the like.

The interface unit 210 may transmit a first request REQ1 to the mobile terminal 400 to thereby receive a mobile terminal identifier TID and a card identifier CID from the mobile terminal 400. However, the present invention is not limited thereto, and the mobile terminal identifier TID and the card identifier CID may be automatically transmitted to the interface unit 210 of the authentication system 200a when the mobile terminal 400 tags the card 500 via NFC. To achieve this, an application program for automatically transmitting the mobile terminal identifier TID and the card identifier CID may be executed on the mobile terminal 400. Hereinafter, an application program that is downloaded to and executed on the mobile terminal 400 is referred to as App.

The interface unit 210 may transmit the mobile terminal identifier TID and the card identifier CID to the mobile terminal identifier/member identifier matching unit 220 and the member identifier/card identifier matching unit 230, respectively. The mobile terminal identifier/member identifier matching unit 220 searches for a member identifier MID of the authentication system 200a corresponding to the mobile terminal identifier TID (S120). For example, the mobile terminal identifier/member identifier matching unit 220 may transmit a first query Q1 for the mobile terminal identifier TID to the encryption information DB 240 and receive a member identifier MID as a response to the first query Q1, thereby identifying the member identifier MID corresponding to the mobile terminal identifier TID.

The mobile terminal identifier/member identifier matching unit 220 may transmit a search result RST1 containing the member identifier MID to the member identifier/card identifier matching unit 230. The member identifier/card identifier matching unit 230 may check whether the card identifier CID is included in a card identifier list CLIST registered with the authentication system 200a (S130). The card identifier list CLIST corresponds to the member identifier MID and is registered with the authentication system 200a along with the member identifier MID. For example, the member identifier/card identifier matching unit 230 may transmit a second query Q2 for the member identifier MID to the encryption information DB 240 and receive the card identifier list CLIST as a response to the second query Q2 from the encryption information DB 240, thereby verifying whether the card identifier CID received from the mobile terminal 400 is included in the card identifier list CLIST. Alternatively, the member identifier/card identifier matching unit 230 may transmit a second query Q2 for the member identifier MID and the card identifier CID to the encryption information DB 240 and receive information about whether the card identifier CID received from the mobile terminal 400 is included in the card identifier list CLIST as a response to the second query Q2.

The authentication determination unit 250 may receive a verification result RST2 indicating whether the card identifier CID is included in the card identifier list CLIST from the member identifier/card identifier matching unit 230 to thereby generate an authentication result RST_A confirming user authentication (S140). When the card identifier CID is included in the card identifier list CLIST corresponding to the member identifier MID (YES in operation S130), the authentication determination unit 250 generates an authentication result RST_A confirming that the user is authenticated (S142). On the other hand, when the card identifier CID is not included in the card identifier list CLIST (NO in operation S130) corresponding to the member identifier MID, the authentication determination unit 250 generates an authentication result RST_A confirming that the user is not authenticated (S144).

The authentication result RST_A may be transmitted to the interface unit 210. The user authentication operation performed by the authentication system 200a as described above may be performed in response to a second request REQ2 received from the mobile terminal 400. As a response RSP to the second request REQ2, the interface unit 210 may transmit the authentication result RST_A to the mobile terminal 400 via the first network 300. However, the present invention is not limited thereto. The user authentication operation may also be performed in response to the second request REQ2 received from an authentication requester 700. The authentication requester 700 is an external service provider that may communicate with the authentication system 200a via a second network 600. The second network 600 may be the same as the first network 300. However, the present invention is not limited thereto, and the second network 600 may be a secure network communicated through authentication between the authentication system 200a and the authentication requester 700. As the response RSP to the second request REQ2, the interface unit 210 may transmit the authentication result RST_A to the external service provider 700 via the second network 600.

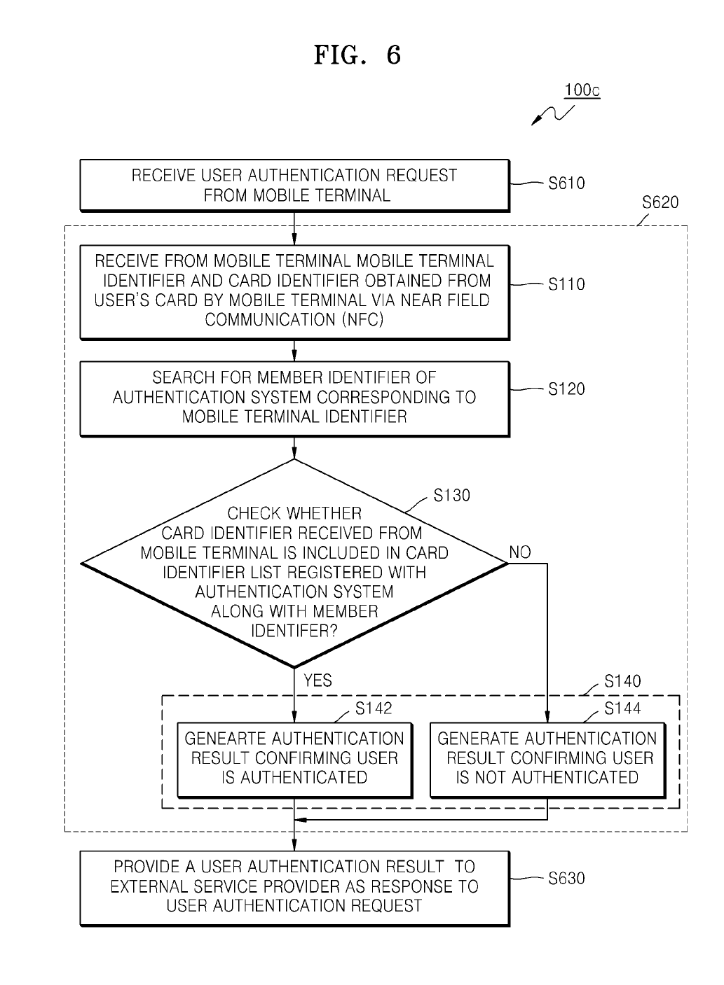

Alternatively, an authentication request (the second request REQ2) may be received from the mobile terminal 400, and the response RSP to the authentication request may be transmitted to the mobile terminal 400 and the authentication requester 700. The authentication request and processing thereof will be described in more detail below with reference to FIGS. 6 through 8.

Although not shown, the authentication system 200a may further include a processor (not shown) for performing the above-described authentication operation.

As described above, according to the present embodiment, the mobile terminal 400 acquires a card identifier CID required for authentication and transmits the card identifier CID to the authentication system 200a, instead of storing the card identifier CID therein, which in turn processes the card identifier CID. Thus, risks such as security exposure due to loss or hacking of the mobile terminal 400 may be prevented. Furthermore, according to the present embodiment, an authentication operation may be performed when the mobile terminal 400 acquires and transmits a card identifier CID using NFC, thereby allowing user convenience. In addition, since authentication is successfully made only when a card holder is the same as the owner of the mobile terminal 400, security may be strengthened further.

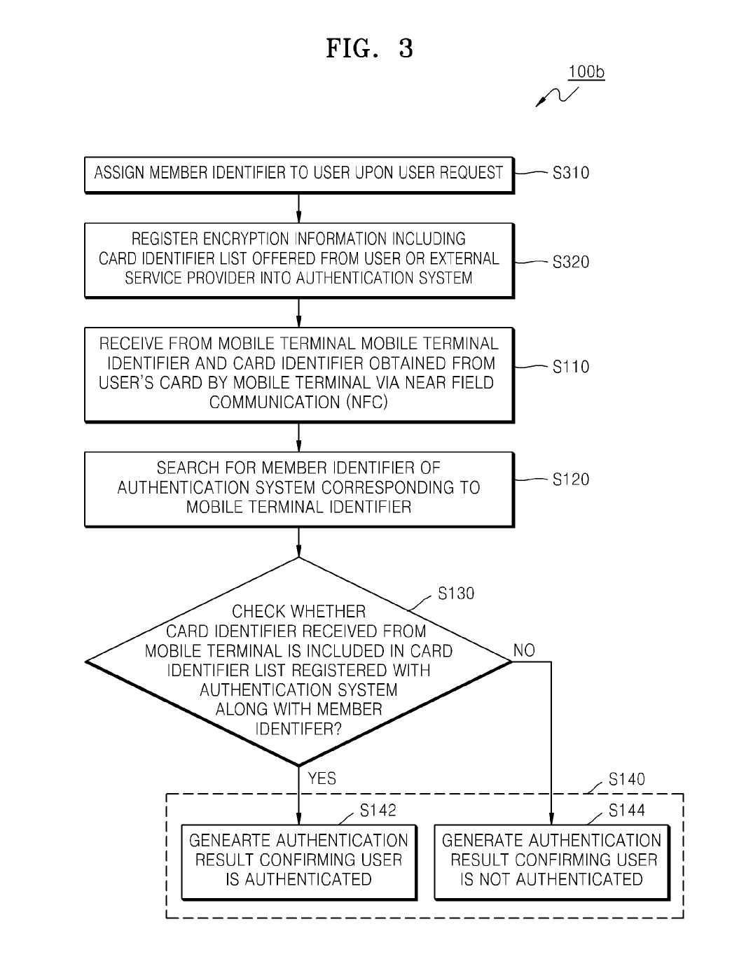

FIG. 3 is a flowchart of an authentication method 100b that is performed by the authentication system 200a of FIG. 2, according to another exemplary embodiment of the present invention. Referring to FIGS. 2 and 3, the authentication method 100b according to the present embodiment may further include assigning a member identifier MID to a user upon user request (S310), wherein the assigning is performed by the authentication system 200a, and registering encryption information containing a card identifier list CLIST offered from a user or external service provider to the authentication system 200a (S320). After registering membership and encryption information, an authentication operation may be performed as shown in FIG. 1.

In operation S310 of assigning the member identifier MID to the user, the authentication system 200a may provide a format for membership registration to the user, and the user may enter information necessary for membership registration. In order to strengthen security, the authentication system 200a may perform membership registration after verifying the identity of the user through an authentication certificate, mobile authentication, or Internet Personal Identification Number (I-PIN). In operation S320, the encryption information may include at least one card identifier CID that the user desires to use for an authentication operation and a user identifier (a digital certificate, fingerprint information, etc.) and an account number that are used in embodiments described below. The encryption information may be provided directly to the authentication system 200a by the user, or by a service provider that provides encryption information, such as a card company or bank. Member information containing the member identifier MID and the encryption information may be stored in the encryption information DB 240.

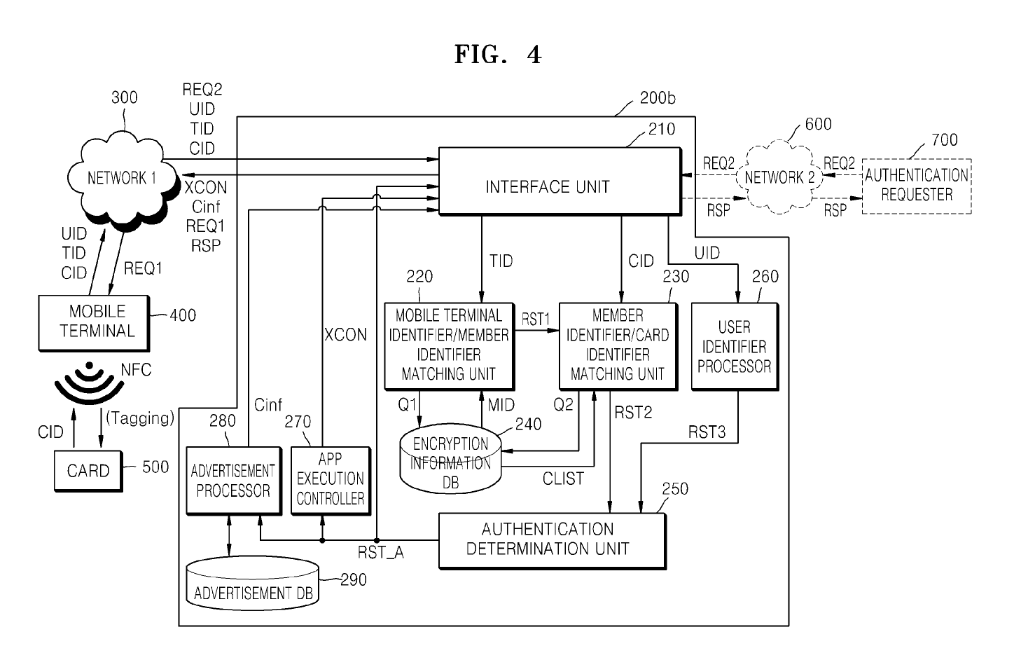

FIG. 4 illustrates an authentication system 200b according to another exemplary embodiment of the present invention. Like the authentication system 200a, the authentication system 200b according to the present embodiment may further include an interface unit 210, a mobile terminal identifier/member identifier matching unit 220, a member identifier/card identifier matching unit 230, an encryption information DB 240, and an authentication determination unit 250. The authentication system 200b may further include at least one selected from a user identifier processor 260, an app execution controller 270, and an advertisement processor 280. However, for convenience only, FIG. 4 shows that the authentication system 200b includes all of the user identifier processor 260, the app execution controller 270, and the advertisement processor 280.

The user identifier processor 260 may check whether a user identifier UID received from a mobile terminal 400 corresponds to the member identifier MID. The user identifier UID may include at least one selected from a user's digital signature, password, and fingerprint information. The user identifier UID may be information that is unique to the user. The user identifier UID may be received from the interface unit 210 and stored in the encryption information DB 240 as encryption information through operation S320 illustrated in FIG. 3.

Although not shown in FIG. 4, the user identifier processor 260 may receive from the encryption information DB 240 encryption information corresponding to the member identifier MID received from the mobile terminal identifier/member identifier matching unit 220 and compare the encryption information with the user identifier UID received from the interface unit 210. The authentication determination unit 250 may determine whether the user is authenticated based on a verification result RST indicating whether the user identifier UID corresponds to the member identifier MID, together with a verification result RST2 indicating whether the card identifier CID is included in a card identifier list CLIST corresponding to the member identifier MID.

The app execution controller 270 generates control information necessary to control execution of an application program, i.e., app downloaded to the mobile terminal 400 based on the authentication result RST_A. The control information XCON may be transmitted to the mobile terminal via the interface unit 210, and app for the mobile terminal 400 may be executed in response to the control information XCON. For example, app requiring user authentication may be executed in response to the control information XCON without the need for inputting separate authentication information. Upon receipt of the control information XCON, app for mobile banking may be executed to perform a bank account without the need for separate user authentication. For another example, if the control information is not received, the mobile terminal 400 may control execution of app by internally processing the authentication result RST_A.

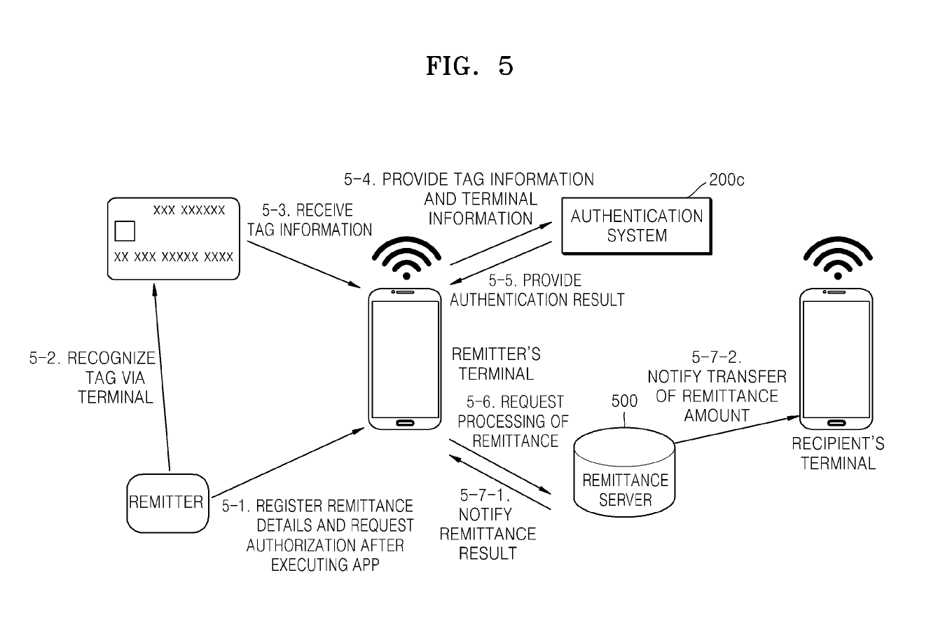

FIG. 5 illustrates an example of mobile banking processing using an authentication system 200c according to another exemplary embodiment of the present invention. Referring to FIG. 5, a mobile terminal, i.e., a remitter's terminal may allow a remitter (a user) to execute app related to mobile banking, thereby registering the amount to be remitted and a bank account number of a recipient and requesting authorization (5-1). In this case, the remitter may additionally register in the app recipient information such as a recipient's name and mobile phone number. Then, an NFC tag of a card may be recognized via the remitter's terminal (5-2). Tag information, i.e., a card identifier is transmitted to the remitter's terminal (5-3).

The tag information and terminal information (terminal identifier) is transmitted to the authentication system 200c (5-4). The authentication system 200c provides an authentication result confirming user authentication to the remitter's terminal by performing the above-described authentication operation. Like the authentication system 200a of FIG. 2, the authentication system 200c illustrated in FIG. 5 may include the interface unit 210, the mobile terminal identifier/member identifier 220, the member identifier/card identifier matching unit 230, the encryption information DB 240, and the authentication determination unit 250. Furthermore, the authentication system 200c may further include at least one selected from the identifier processor 260, the app execution controller 270, and the advertisement processor 280 illustrated in FIG. 4.

The remitter's terminal may receive the authentication result and request processing of remittance from a remittance server 500. Otherwise, as in the embodiment shown in FIG. 4, the authentication system 200c may transmit control information XCON necessary for directly controlling app for performing mobile banking on the remitter's terminal to the remitter's terminal, and the app may automatically request processing of remittance in response to the control information XCON. The remittance server 500 may be a financial company's server that provides remittance services. The remittance server 500 may perform remittance upon request from the remitter, transmit a remittance result to the remitter's terminal (5-7-1), and notify transfer of a remittance amount to a recipient's terminal (5-7-2).

The authentication system 200c may include the remittance server 500. When the authentication system 200c according to the present embodiment is used, secure and convenient mobile banking may be performed.

Referring back to FIG. 4, the advertisement processor 280 selects advertisement information Cinf corresponding to a user based on an authentication result RST_A confirming user authentication. The advertisement information Cinf may be provided by an advertisement DB 290. While the authentication system 200b includes the advertisement DB 290, the present invention is not limited thereto. The advertisement DB 290 may be provided by an advertising agency, etc., outside of the authentication system 200b, and furnish the advertisement information Cinf to the advertisement processor 280 via a communication.

The advertisement information Cinf may be selected based on member information corresponding to the member identifier MID. For example, an advertisement in an area that is set as an area of interest upon membership subscription may be selected. Alternatively, the advertisement information Cinf may be selected based on location information such as global positioning system (GPS) information and the mobile terminal identifier TID. In detail, the advertisement processor 280 may receive location information of the mobile terminal 400 identified as the mobile terminal identifier TID from a telecommunication service provider and select an advertisement corresponding to the location information, such as discount coupons dispensed by a café near the location of the mobile terminal 400. Alternatively, the advertisement information Cinf may include events and discount information provided by a card company that issues a tagging card 500.

When the user receives the advertisement information Cinf via the mobile terminal 400, a service provider such as an advertising agency or card company may provide rewards for receiving the advertisement information Cinf. The selected advertisement information Cinf is transmitted to the mobile terminal 400 via the interface unit 210.

FIG. 6 is a flowchart of an authentication method 100c that is performed by an authentication system, according to another exemplary embodiment of the present invention. Referring to FIG. 6, the authentication method 100c according to the present embodiment includes receiving a user authentication request from a mobile terminal (S610), performing an authentication operation in response to the user authentication request (S620), and providing a user authentication result obtained by performing the authentication operation to an external service provider as a response to the user authentication request (S630). Operation S620 may be performed in the same manner as the authentication method 100a of FIG. 1.

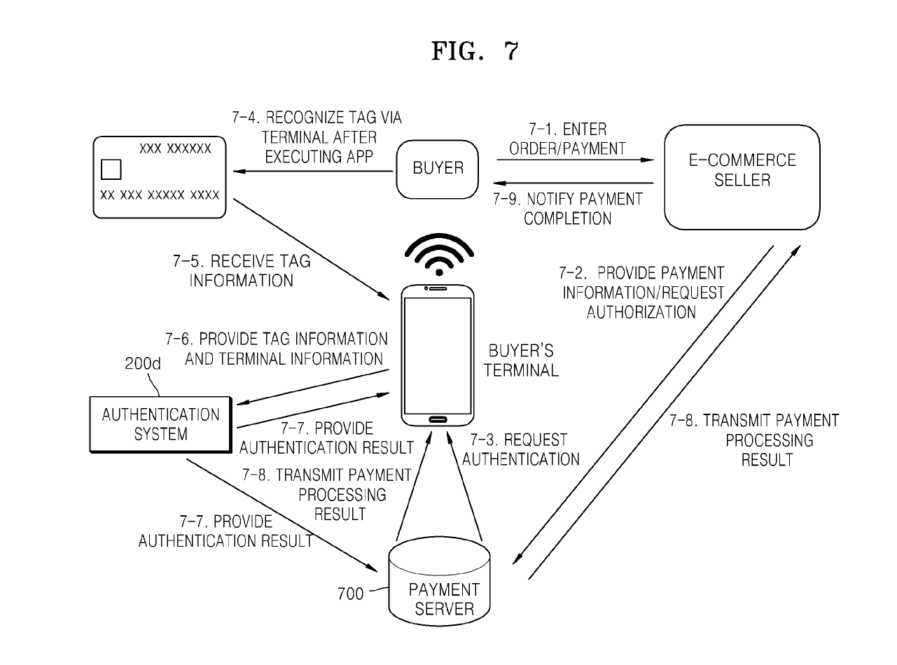

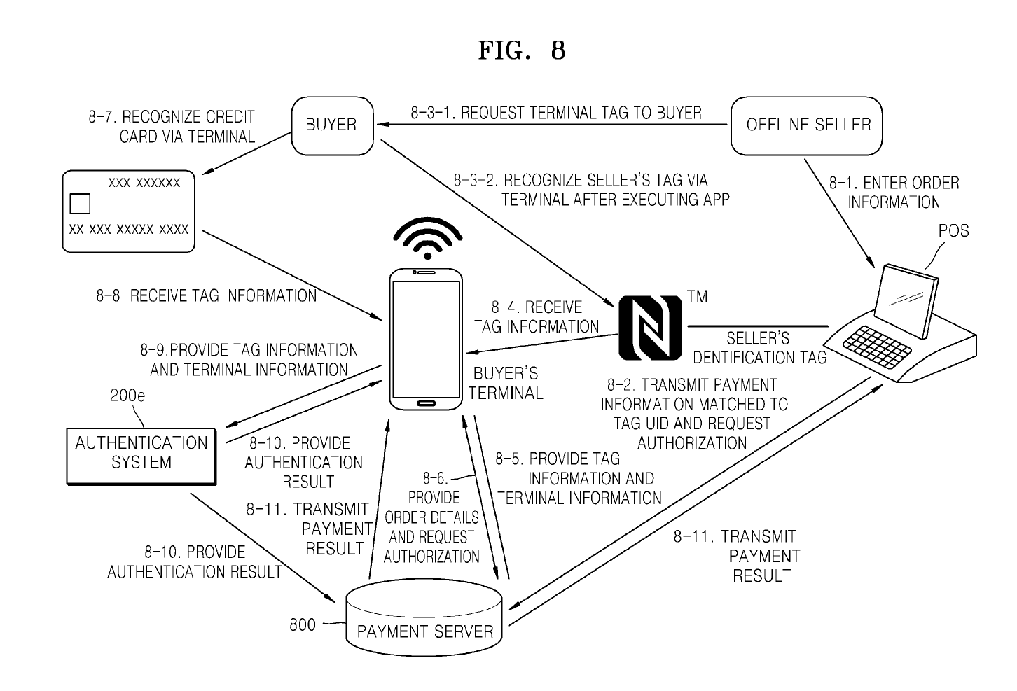

The external service provider may be a service provider that provides payment or account transfer services by processing a payment or remittance request from an online or offline seller. The external service provider may be the remittance server 500 for providing account transfer services as in the embodiment shown in FIG. 5. Embodiments in which the external service provider provides payment services will now be described in detail with reference to FIGS. 7 and 8.

FIGS. 7 and 8 illustrate authentication systems 200d and 200e and authentication methods performed by the authentication systems 200d and 200e according to other exemplary embodiment of the present invention. First, referring to FIG. 7, a payment server 700 may process payment upon a payment request from an online seller (E-commerce seller). In detail, when a buyer, i.e., a user purchases goods or services from the online seller, order and payment information is input to an online seller's website (or an open market acting as an agent for the online seller) (7-1). The online seller's website then provides payment information to the payment server 700 and requests authorization (7-2), and the payment server 700 requests user authentication for payment from a mobile terminal, i.e., a buyer's terminal (7-3). For example, the request for user authentication (7-3) may be forwarded to the buyer's terminal in the form of a push, short message service (SMS), or the like. The buyer's terminal receives tag information (a card identifier) (7-5) by tagging an NFC tag (7-4) of a card 500.

The tag information and the terminal information (i.e., mobile terminal identifier) is input to the authentication system 200d (7-6), and an authentication result obtained by performing an authentication operation is provided to the buyer's terminal and the payment server 700 (7-7). The authentication system 200d may perform the authentication operation in the same manner as illustrated in FIGS. 2 and 4. When user authentication is confirmed, the payment server 700 performs payment and provides a payment result to the online seller's website and the buyer's terminal (7-8). The online seller's website, etc. may notify payment completion to the buyer (7-9). For example, the payment completion may be notified via the buyer's terminal or email.

Next, referring to FIG. 8, a payment server 800 may process payment upon a payment request from an offline seller. In detail, when a buyer, i.e., a user purchases goods or services from the offline seller, order information is input to a point of sale (POS) system for the offline seller (8-1). The present invention is not limited thereto, and the order information may be input to an offline seller's computer, tablet PC, or smartphone. For convenience of explanation, it is assumed hereinafter that the order information is input to the POS system.

The POS system for the offline seller provides payment information to the payment server 800 and requests authorization (8-2), and tagging is performed on an offline seller's identification tag (NFC tag) via a buyer's terminal (8-3-1 and 8-3-2). The offline seller's identification tag may be attached to an offline seller's counter, display stand, customer table, etc., and a plurality of identification tags may be present. The buyer's terminal receives tag information of the offline seller's identification tag (8-4). The tag information and terminal information (i.e., a mobile terminal identifier) is input to the payment server 800 (8-5). The payment server 800 provides order details to the buyer's terminal and requests user authorization (authentication) for payment from the buyer's terminal (8-6). For example, the request for user authorization (authentication) may be forwarded to the buyer's terminal in the form of a push, SMS, or the like.

The buyer's terminal receives tag information (a card identifier) by tagging an NFC tag of a card. The tag information (card identifier) and the terminal information (mobile terminal identifier) is input to the authentication system 200e (8-9), and an authentication result obtained by performing an authentication operation is provided to the buyer's terminal and the payment server 800 (8-10). The authentication system 200e may perform the authentication operation in the same manner as illustrated in FIGS. 2 and 4. When user authentication is confirmed, the payment server 800 performs payment and provides a payment result to the POS system for the offline seller and the buyer's terminal (8-11).

The authentication system 200d and the authentication system 200e of FIGS. 7 and 8 may include the payment servers 700 and 800, respectively. In this way, when the authentication systems 200d and 200e according to the embodiments of the present invention are used, a user's mobile terminal may be used as a payment terminal, thereby ensuring safe and convenient payment while preventing hacking of credit card information.

The terminology used herein is for the purpose of describing particular embodiments only and is not intended to limit the meaning thereof or the scope of the present invention defined by the following claims. While one or more embodiments of the present invention have been described with reference to the figures, it will be understood by those of ordinary skill in the art that various changes in form and details may be made therein without departing from the spirit and scope of the present invention as defined by the claims.

What is claimed is:

1. An authentication method that is performed by an authentication system, the method comprising:
receiving from a user's mobile terminal a mobile terminal identifier and a card identifier, wherein the card identifier is obtained from a user's card by the user's mobile terminal via Near Field Communication (NFC);
searching for a member identifier of the authentication system corresponding to the mobile terminal identifier;
checking whether the card identifier received from the user's mobile terminal is included in a card identifier list registered with the authentication system along with the member identifier; and
generating the result of user authentication based on the result of checking of whether the card identifier is included in the card identifier list.

2. The method of claim 1, further comprising:
assigning the member identifier to the user upon user request, wherein the assigning is performed by the authentication system; and
registering encryption information including the card identifier list offered from the user or an external service provider to the authentication system.

3. The method of claim 1, further comprising transmitting advertisement information corresponding to the user to the user's mobile terminal based on the result of user authentication.

4. The method of claim 1, further comprising transmitting to the user's mobile terminal control information necessary to control execution of an application program downloaded to the user's mobile terminal based on the result of user authentication.

5. The method of claim 1, further comprising:
receiving at least one selected from a user's electronic signature, password, and fingerprint information from the user's mobile terminal as a user's identifier; and
checking whether the user identifier corresponds to the member identifier,
wherein the generating of the result of user authentication is performed based on the result of checking of whether the user identifier corresponds to the member identifier, together with the result of checking of whether the card identifier is included in the card identifier list.

6. The method of claim 1, further comprising:
receiving an authentication request from the user's mobile terminal; and
providing the result of user authentication to an external service provider as a response to the authentication request.

7. The method of claim 6, wherein the external service provider is a service provider that provides payment or account transfer services by processing a payment or remittance request from an online or offline seller.

8. An authentication method performed in a mobile terminal, the method comprising:
receiving a card identifier from a user's card via Near Field Communication (NFC);
transmitting a mobile terminal identifier and the card identifier to an external authentication system;
receiving an authentication result from the external authentication system based on the mobile terminal identifier and the card identifier; and
processing an authentication procedure required for an application program downloaded to the mobile terminal, based on the authentication result.
